(19) United States
(12) Patent Application Publication
(10) Pub. No.: US 2024/0031290 A1
(43) Pub. Date: Jan. 25, 2024

(54) CENTRALIZED SERVICE INSERTION IN AN ACTIVE-ACTIVE LOGICAL SERVICE ROUTER (SR) CLUSTER

(71) Applicant: VMware, Inc., Palo Alto, CA (US)

(72) Inventors: Bo LIN, Beijing (CN); Yong WANG, San Jose, CA (US); Dongping CHEN, Beijing (CN); Xinhua HONG, Campbell, CA (US); Xinyu HE, Beijing (CN)

(73) Assignee: VMware, Inc., Palo Alto, CA (US)

(21) Appl. No.: 17/938,975

(22) Filed: Sep. 7, 2022

(30) Foreign Application Priority Data
Jul. 21, 2022 (WO) PCT/CN2022/106946

(51) Int. Cl. H04L 45/76; H04L 47/125; H04L 45/74

(52) U.S. Cl. CPC H04L 45/76; H04L 47/125; H04L 45/74

(57) ABSTRACT

Example methods and systems for centralized service insertion in an active-active cluster are described. In one example, a first service endpoint may operate in an active mode on a first logical service router (SR) supported by the computer system. The first service endpoint may be associated with a second service endpoint operating on the second logical SR in a standby mode. The first logical SR and the second logical SR may be assigned to a first sub-cluster of the active-active cluster. In response to receiving a service request originating from a virtualized computing instance, the service request may be processed using the first service endpoint according to a centralized service that is implemented by both the first service endpoint and the second service endpoint. A processed service request may be forwarded towards a destination capable of generating and sending a service response in reply to the processed service request.

### CROSS-REFERENCE TO RELATED APPLICATION

The present application claims the benefit of Patent Cooperation Treaty (PCT) Application No. PCT/CN2022/106946, filed Jul. 21, 2022, which is incorporated herein by reference.

### BACKGROUND

Virtualization allows the abstraction and pooling of hardware resources to support virtual machines in a Software-Defined Networking (SDN) environment, such as a Software-Defined Data Center (SDDC). For example, through server virtualization, virtual machines (VMs) running different operating systems may be supported by the same physical machine (e.g., referred to as a “host”). Each VM is generally provisioned with virtual resources to run an operating system and applications. Further, through SDN, benefits similar to server virtualization may be derived for networking services. For example, logical overlay networks may be provisioned, changed, stored, deleted and restored programmatically without having to reconfigure the underlying physical hardware architecture. In practice, it is desirable to deploy logical routers to provide networking service(s) to various VMs in the SDN environment, such as domain name system (DNS) forwarding, etc.

### BRIEF DESCRIPTION OF DRAWINGS

FIG. 1 is a schematic diagram illustrating an example software-defined networking (SDN) environment in which centralized service insertion in an active-active logical service router (SR) cluster may be implemented;

FIG. 2 is a schematic diagram illustrating an example physical view of hosts SDN environment in FIG. 1;

FIG. 3 is a flowchart of an example process for a computer system to implement a centralized service insertion in an active-active logical SR cluster;

FIG. 4 is a schematic diagram illustrating example configurations to facilitate centralized service insertion in an active-active logical SR cluster;

FIG. 5 is a schematic diagram illustrating active-standby service endpoints before, during and after a failover;

FIG. 6 is a flowchart of an example detailed process for centralized service insertion in an active-active logical SR cluster;

FIG. 7 is a schematic diagram illustrating a first example of centralized service insertion for northbound traffic with load balancing enabled;

FIG. 8 is a schematic diagram illustrating a first example of centralized service insertion for southbound traffic with load balancing enabled;

FIG. 9 is a schematic diagram illustrating a second example of centralized service insertion for northbound traffic with load balancing not enabled; and

FIG. 10 is a schematic diagram illustrating a second example of centralized service insertion for southbound traffic with load balancing not enabled.

### DETAILED DESCRIPTION

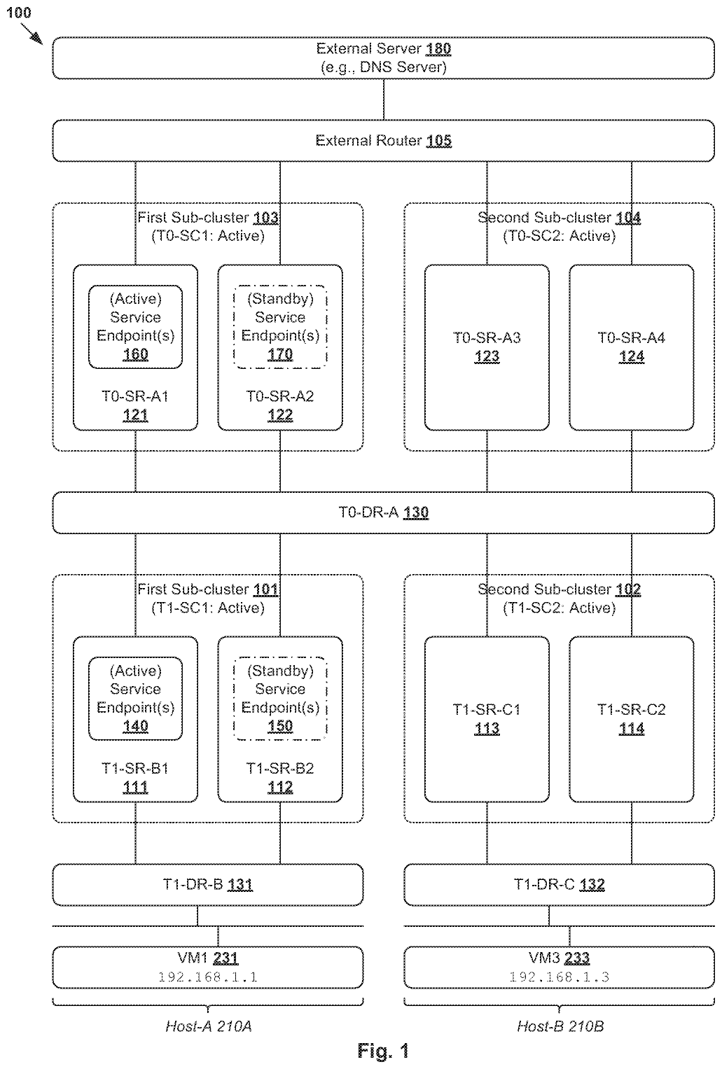

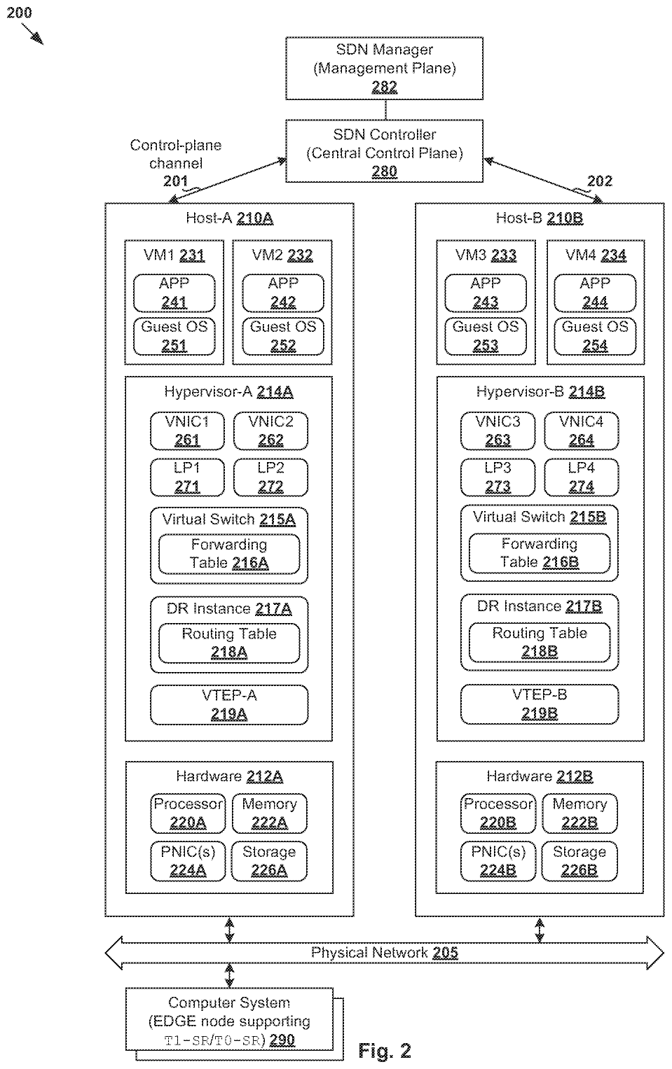

According to examples of the present disclosure, centralized service insertion may be implemented in an active-active cluster that includes at least a first logical service router (SR) supported by a computer system (e.g., EDGE node 290 in FIG. 2), a second logical SR and a third logical SR. One example may involve the computer system operating a first service endpoint (e.g., 140 in FIG. 1) in an active mode on the first logical SR. The first service endpoint may be associated with a second service endpoint (e.g., 150 in FIG. 1) operating on the second logical SR in a standby mode. The first logical SR and the second logical SR may be assigned to a first sub-cluster (e.g., 101 in FIG. 1) of the active-active cluster.

The computer system may receive a service request originating from a virtualized computing instance (e.g., VM1 231 in FIG. 1), such as via (a) a logical distributed router (DR), (b) the second logical SR in the first sub-cluster, or (c) the third logical SR in a second sub-cluster (e.g., 102 in FIG. 1). In response, the service request may be processed using the first service endpoint according to a centralized service that is implemented by both the first service endpoint and the second service endpoint. A processed service request may be forwarded towards a destination capable of generating and sending a service response in reply to the processed service request. Various examples will be described using FIGS. 1-10.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

Challenges relating to service insertion will now be explained using FIG. 1 and FIG. 2. In particular, FIG. 1 is a schematic diagram illustrating example software-defined networking (SDN) environment 100 in which centralized service insertion in an active-active logical SR cluster may be performed. FIG. 2 is a schematic diagram illustrating example physical view 200 of hosts in SDN environment 100 in FIG. 1. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.). Each host may be supporting any number of virtual machines (e.g., tens or hundreds).

In the example in FIG. 1, multiple logical routers (see 111-114, 121-124, 130-132) may be deployed in SDN environment 100 to facilitate east-west connectivity among various virtual machines (VMs) as well as north-south connectivity with an external network (e.g., Internet). As shown in more detail in FIG. 2, each host 210A/210B may include suitable hardware 212A/212B and virtualization software (e.g., hypervisor-A 214A, hypervisor-B 214B) to support virtual machines (VMs). For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

SDN controller 280 and SDN manager 282 are example network management entities in SDN environment 100. One example of an SDN controller is the NSX controller component of VMware NSX® (available from VMware, Inc.) that operates on a central control plane. SDN controller 280 may be a member of a controller cluster (not shown for simplicity) that is configurable using SDN manager 282. Network management entity 280/282 may be implemented using physical machine(s), VM(s), or both. To send or receive control information, a local control plane (LCP) agent (not shown) on host 210A/210B may interact with SDN controller 280 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B may implement virtual switch 215A/215B and logical DR instance 217A/217B to handle egress packets from, and ingress packets to, corresponding VMs. In SDN environment 100, logical switches and logical DRs may be implemented in a distributed manner and can span multiple hosts.

For example, logical switch(es) may be deployed to provide logical layer-2 connectivity to VMs 231-234 with other entities in SDN environment 100. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables 218A-B at respective DR instances 217A-B. Routing tables 218A-B may each include entries that collectively implement the respective logical DRs.

Packets may be received from, or sent to, each VM via an associated logical port. For example, logical switch ports 271-274 (labelled “LSP1” to “LSP4” in FIG. 2) are associated with respective VMs 231-234. Here, the term “logical port” or “logical switch port” may refer generally to a port on a logical switch to which a virtualized computing instance is connected. A “logical switch” may refer generally to an SDN construct that is collectively implemented by virtual switches 215A-B in FIG. 2, whereas a “virtual switch” may refer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. Hosts 210A-B may also maintain data-plane connectivity with each other via physical network 205 to facilitate communication among VMs 231-234.

Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). For example in FIG. 1, hypervisor-A 214A implements first VTEP-A 219A associated with (IP address=IP-A, VTEP label=VTEP-A). Hypervisor-B 214B implements second VTEP-B 219B with (IP-B, VTEP-B). Encapsulated packets may be sent via an end-to-end, bi-directional communication path (known as a tunnel) between a pair of VTEPs over physical network 105.

Multi-Tier Topology

Referring to FIG. 1 again, a multi-tier logical network topology may be implemented in SDN environment 100 to provide isolation for multiple tenants. The multi-tiered topology enables both provider (e.g., data center owner) and multiple tenants (e.g., data center tenants) to control their own services and policies. For example, a two-tier topology may include (1) an upper tier-0 (T0) associated with a provider and (2) a lower tier-1 (T1) associated with a tenant. In this case, a logical SR may be categorized as T1-SR (see 111-114) or T0-SR (see 121-124). Similarly, a logical DR may be categorized as T1-DR (see 131-132) or T0-DR (see 130).

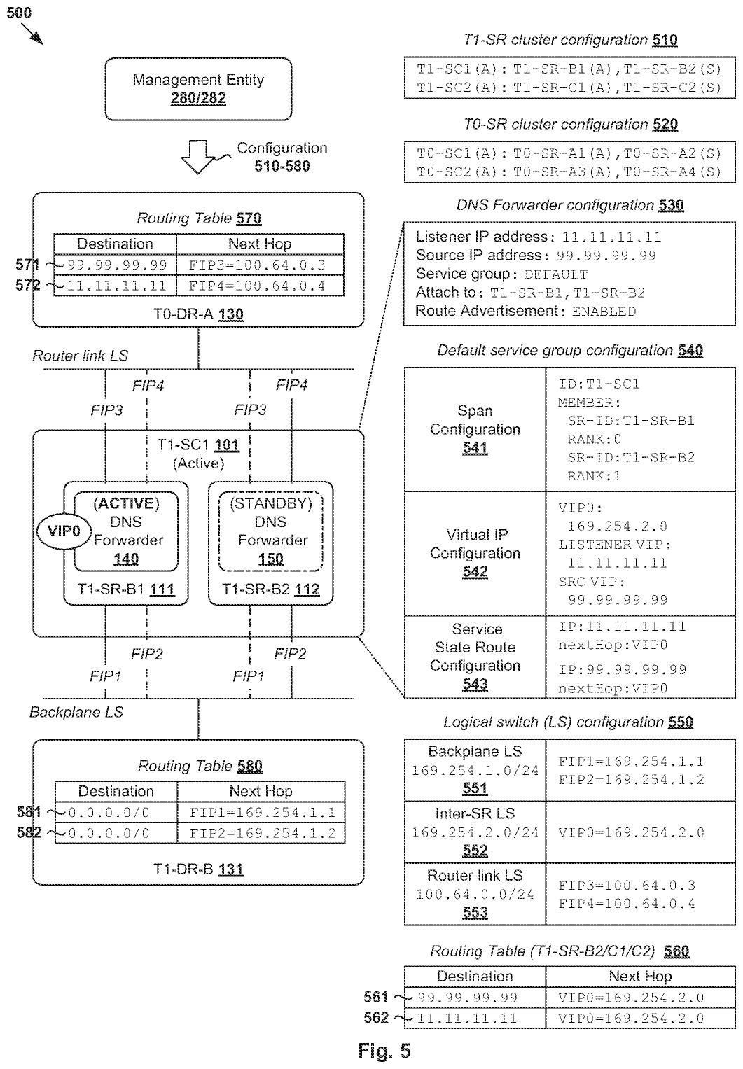

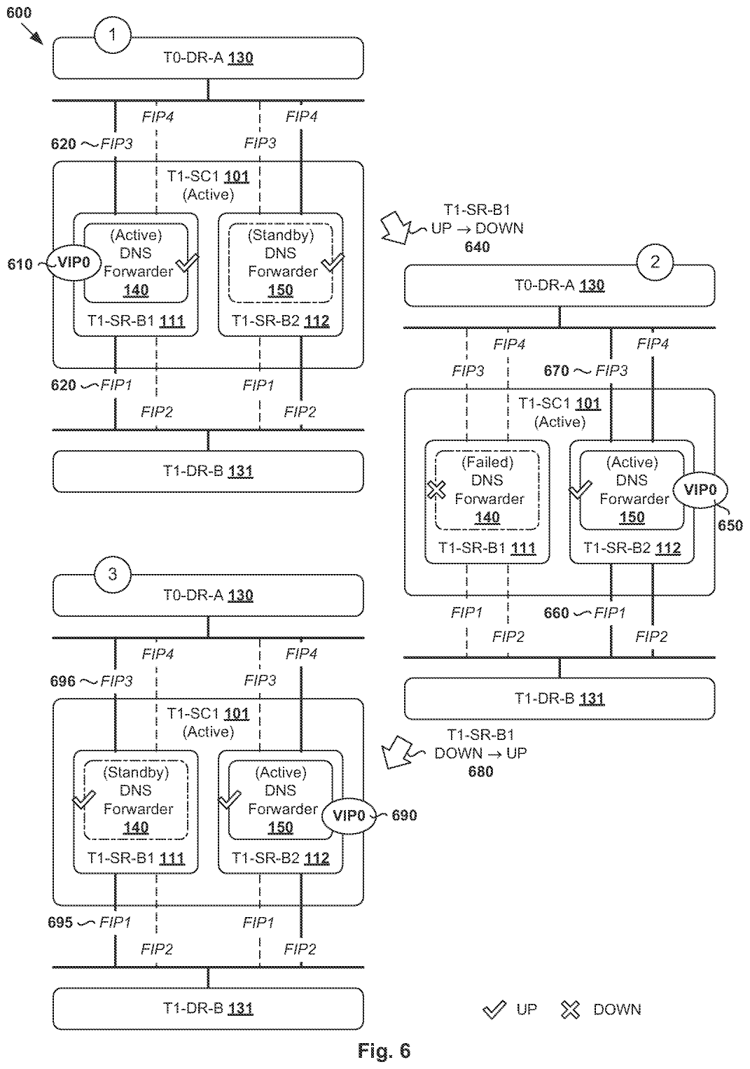

On the lower tier, a T1 logical router (DR or SR) connects VM 231/233 implemented by host 210A/210B to a T0 logical router. On the upper tier, a T0 logical router (DR or SR) connects a T1 logical router to an external router (see 105) and an external server (see 180). In practice, a T0-DR may be connected to a T0-SR via a router link logical switch. A T1-SR may be connected to a T1-DR via a backplane logical switch or segment. A cluster of T1-SRs 111-114 or TO-SRs 121-124 may be connected to each other via an inter-SR logical switch. The router link, inter-SR and backplane logical switches will be explained further using FIGS. 5-6.

Depending on the desired implementation, a logical SR (i.e., T1-SR or TO-SR) may be implemented by a computer system in the form of an EDGE node that is deployed at the edge of a data center. A logical DR (i.e., T1-DR or TO-DR) may span multiple transport nodes, including host 210A/210B and EDGE node(s). For example, four EDGE nodes (not shown for simplicity) may be deployed to support respective T1-SRs 111-114, such as EDGE1 for T1-SR-B1 111, EDGE2 for T1-SR-B2 112, EDGE3 for T1-SR-C1 113 and EDGE4 for T1-SR-C2 114. In this case, instances of T1-DRs 130-132 may span host-A 210A, host-B 210B as well as EDGE1 to EDGE4. Also, TO-SRs 121-124 may be supported by respective EDGE1 to EDGE4, or alternative EDGE node(s).

Centralized Service Insertion

According to examples of the present disclosure, centralized service insertion may be implemented in an active-active logical SR cluster. As used herein, the term “logical SR” may refer generally to a centralized routing component capable of implementing centralized networking service(s) to various endpoints, such as VM1 231 on host-A 210A and VM3 233 on host-B 210B in FIG. 1. The term “logical DR” may refer generally to a distributed routing component spanning, and implemented collectively by, multiple transport nodes. The term “centralized service” may refer generally to a networking service implemented by a logical SR, such as domain name system (DNS) forwarding, load balancing, Internet Protocol Security (IPSec) virtual private network (VPN) service, IP address assignment using dynamic host configuration protocol (DHCP), source network address translation (SNAT), destination NAT (DNAT), etc. The term “stateful service” may refer generally to a service in which processing of a packet may be based on state information generated based on previous packet(s).

Examples of the present disclosure may be performed by any suitable “computer system” capable of supporting a logical SR, such as an EDGE node (see example at 290 in FIG. 2), etc. Depending on the desired implementation, the EDGE node may be implemented using VM(s) and/or a physical machine (i.e., “bare metal machine”), and capable of performing functionalities of a switch, router, bridge, gateway, edge appliance, or any combination thereof. Various examples will be described below using an example computer system capable of supporting a first logical SR and implementing centralized service insertion.

In the following, an example “active-active” cluster will be described using the example in FIG. 1. An example “first logical SR” will be described using T1-SR-B1 111 supporting a “first service endpoint” (see 140 in FIG. 1); example “second logical SR” using T1-SR-B2 112 supporting a “second service endpoint” (see 150 in FIG. 1); example “third logical SR” using T1-SR-C1 113 or T1-SR-C2 114. Further, example “logical DR(s)” will be described using T1-DR-B 131, T1-DR-C 132 and T0-DR-A 130; and “virtualized computing instance” using VM 231/233 on host 210A/210B.

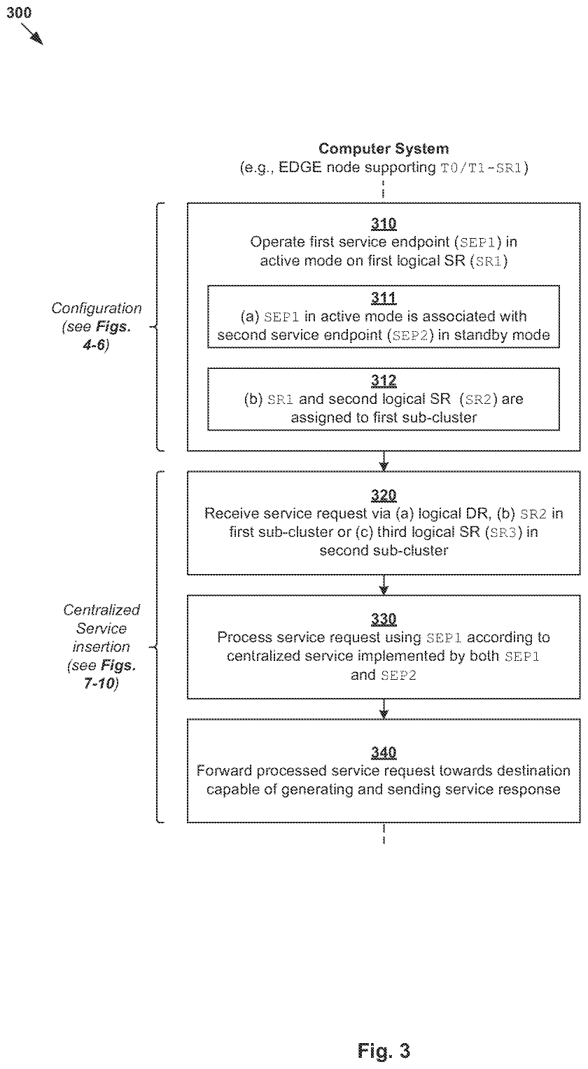

In more detail, FIG. 3 is a flowchart of example process 300 for a computer system to perform centralized service insertion in active-active cluster. Example process 300 may include one or more operations, functions, or actions illustrated by one or more blocks, such as 310 to 340. Depending on the desired implementation, various blocks may be combined into fewer blocks, divided into additional blocks, and/or eliminated. Note that the terms “first” and “second” are used throughout the present disclosure to describe various elements, and to distinguish one element from another. These elements should not be limited by these terms. A first element may be referred to as a second element, and vice versa.

At 310 in FIG. 3, first service endpoint 140 may be operating in an active mode on first logical SR=T1-SR-B1 111. For example, according to an active-standby service configuration, first service endpoint 140 operating in the active mode may be associated with second service endpoint 150 operating on second logical SR=T1-SR-B2 112 in a standby mode. Further, first logical SR=T1-SR-B1 111 and second logical SR=T1-SR-B2 112 may be assigned to first sub-cluster 101 (denoted as T1-SC1) of the active-active cluster in FIG. 1. Second sub-cluster 102 (denoted as T1-SC2) may be configured to include T1-SR-C1 113 and T1-SR-C2 114. Additional sub-cluster(s) may be deployed in SDN environment 100.

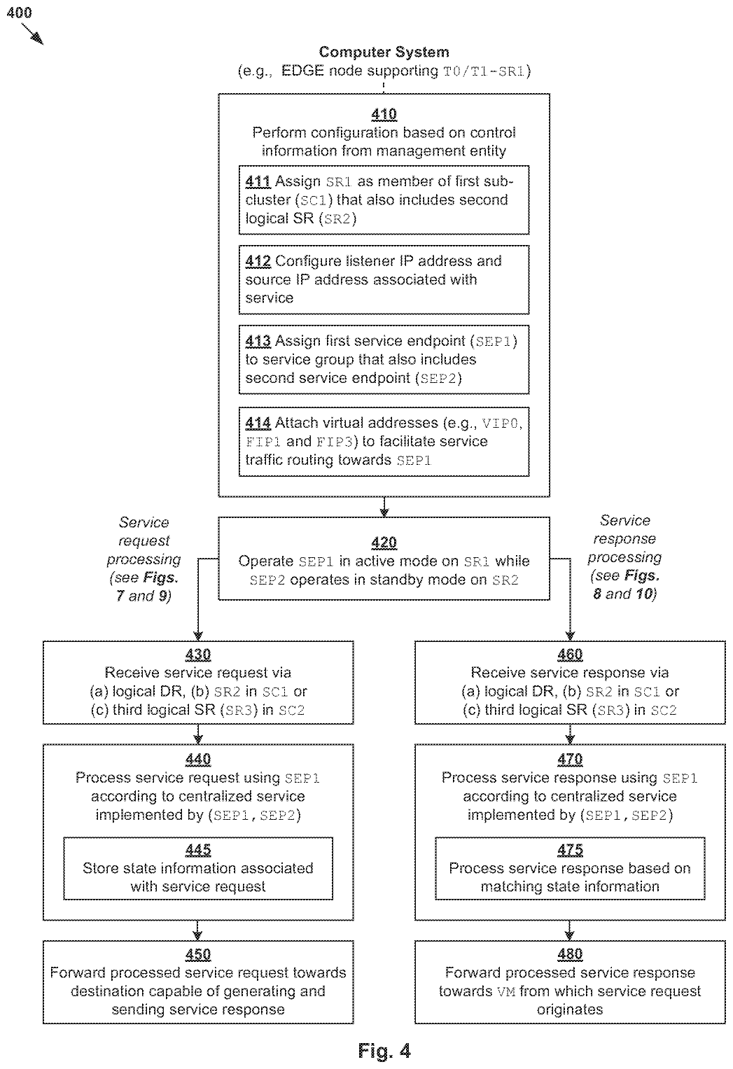

At 320 in FIG. 3, first logical SR=T1-SR-B1 111 may receive a service request originating from VM1 231. In a first example, the service request may be received via logical DR=T1-DR-B 131, such as via a backplane logical switch. In a second example, the service request may be received via second logical SR=T1-SR-B2 112 in first sub-cluster 101 via an inter-SR logical switch. In a third example, the service request may be received via third logical SR=T1-SR-C1 113 or T1-SR-C2 113 in second sub-cluster 102 via the inter-SR logical switch. Configuration of these logical switches and associated addresses will be explained using FIGS. 4-6.

At 330 in FIG. 3, the service request may be processed using first service endpoint 140 on first logical SR=T1-SR-B1 111 according to a centralized service. The centralized service may be implemented by both first service endpoint 140 operating in the active mode and second service endpoint 150 operating in the standby mode. Here, multiple instances of the centralized service are implemented using first service endpoint 140 and second service endpoint 150. However, only one instance of the centralized service (e.g., first service endpoint 140) may be active at one time, and the other instance (e.g., second service endpoint 150) as a backup in case of a failover.

At 340 in FIG. 3, a processed service request may be forwarded towards a destination capable of generating and sending a service response in reply to the processed service request. Depending on the centralized service provided, the “processed” service request may or may not include modification(s) compared to the service request received at block 310. Using centralized service=DNS forwarding as an example, the service request may be a DNS request that requires forwarding to destination=DNS server 180 via one of TO-SRs 121-124 and external router 105.

Using examples of the present disclosure, active-standby service(s) may be implemented in an active-active cluster that includes at least two sub-clusters. Active-active cluster provides SDN environment 100 with stateful services that may be scaled out (e.g., firewall, NAT), or may not be scaled out (e.g., DNS forwarding, load balancing, IPSec VPN). In practice, users may choose to deploy active-active stateful routers to scale out some services, while keeping other services running. Although exemplified using T1-SRs, it should be understood that examples of the present disclosure are applicable to both TO-SRs and T1-SRs. For example in FIG. 1, first service endpoint 160 may be operating in an active mode on first logical SR=T0-SR-A1 121, and second service endpoint 170 in a standby mode on second logical SR=T0-SR-A2 122. Any suitable centralized service(s) may be implemented by first service endpoint 160 and second service endpoint 170.

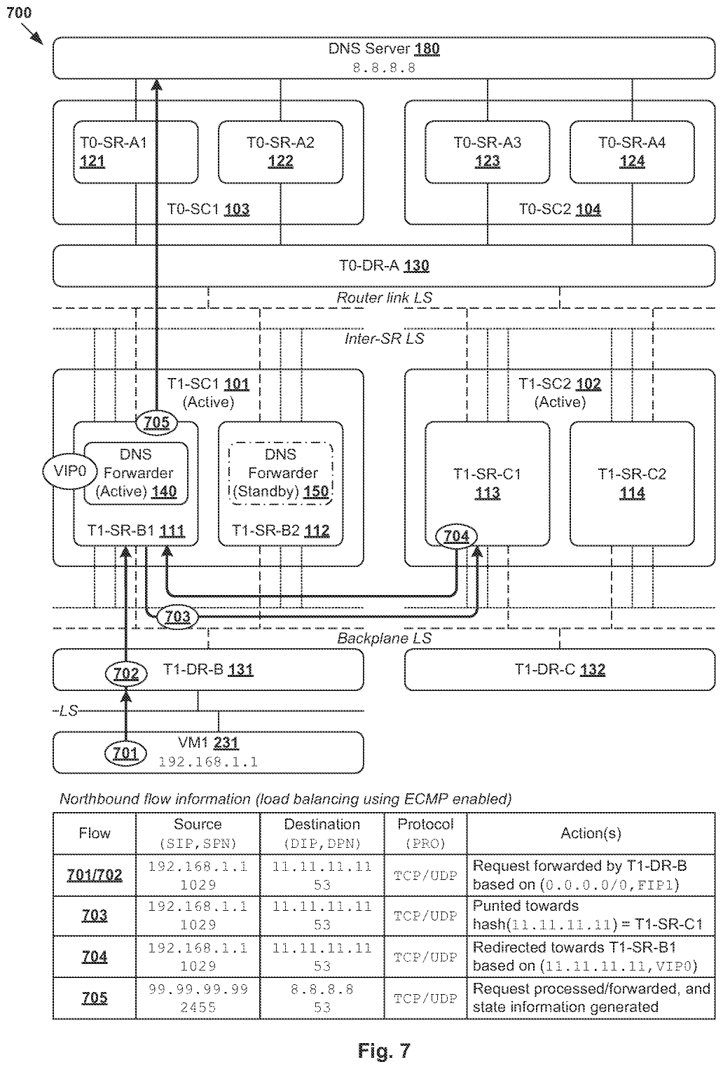

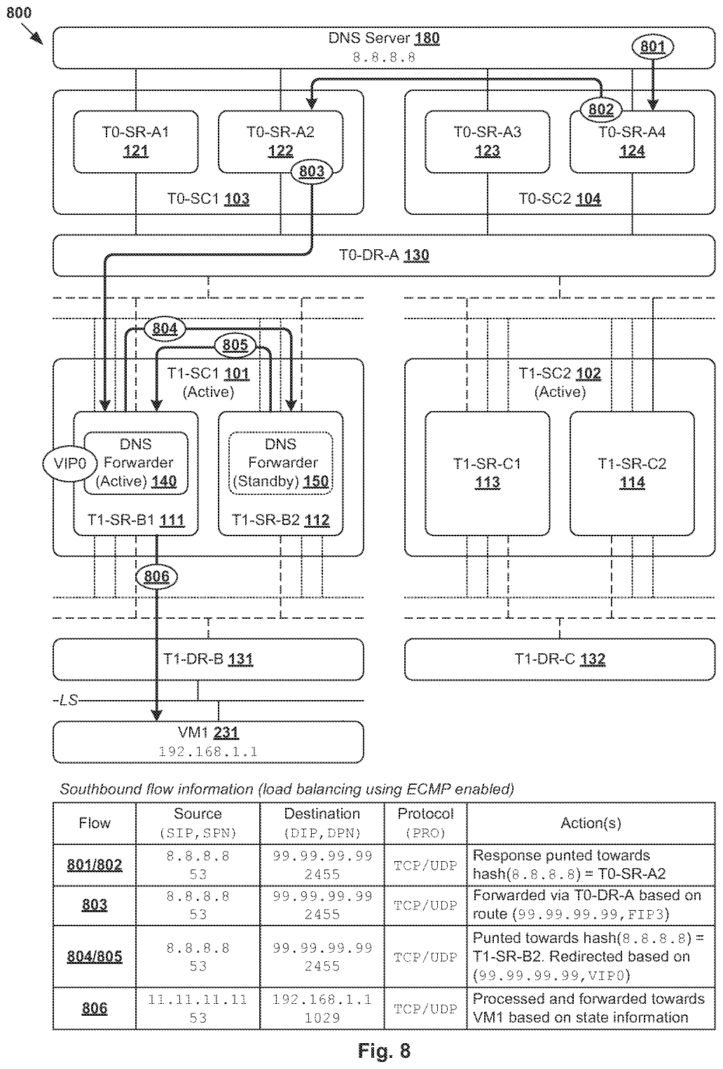

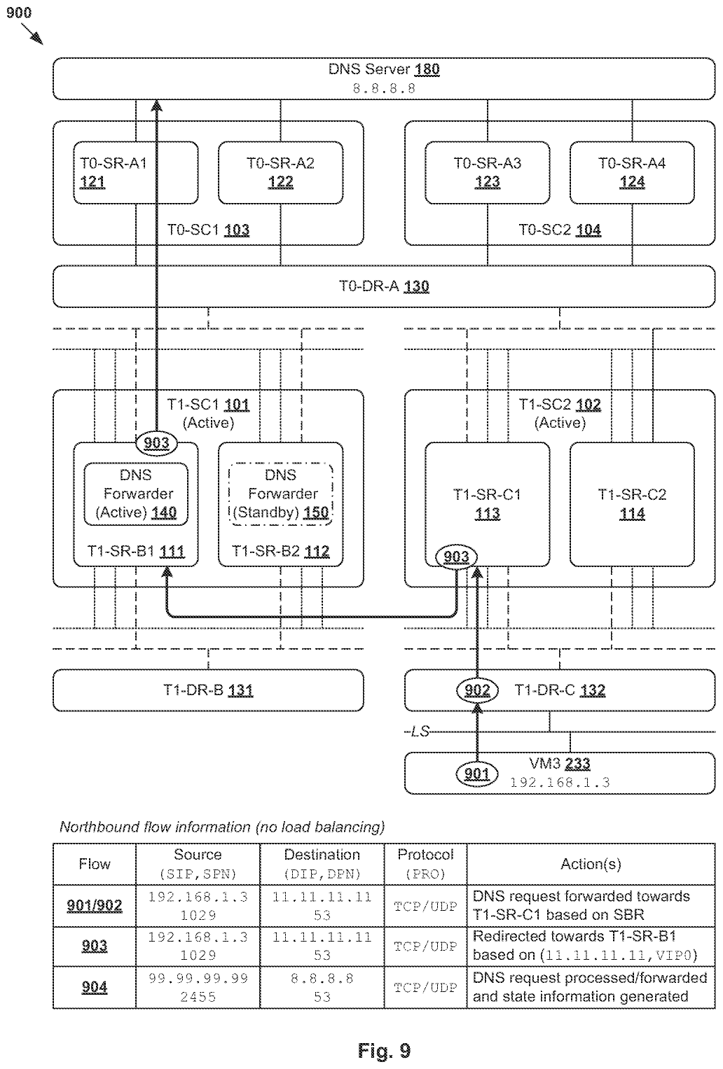

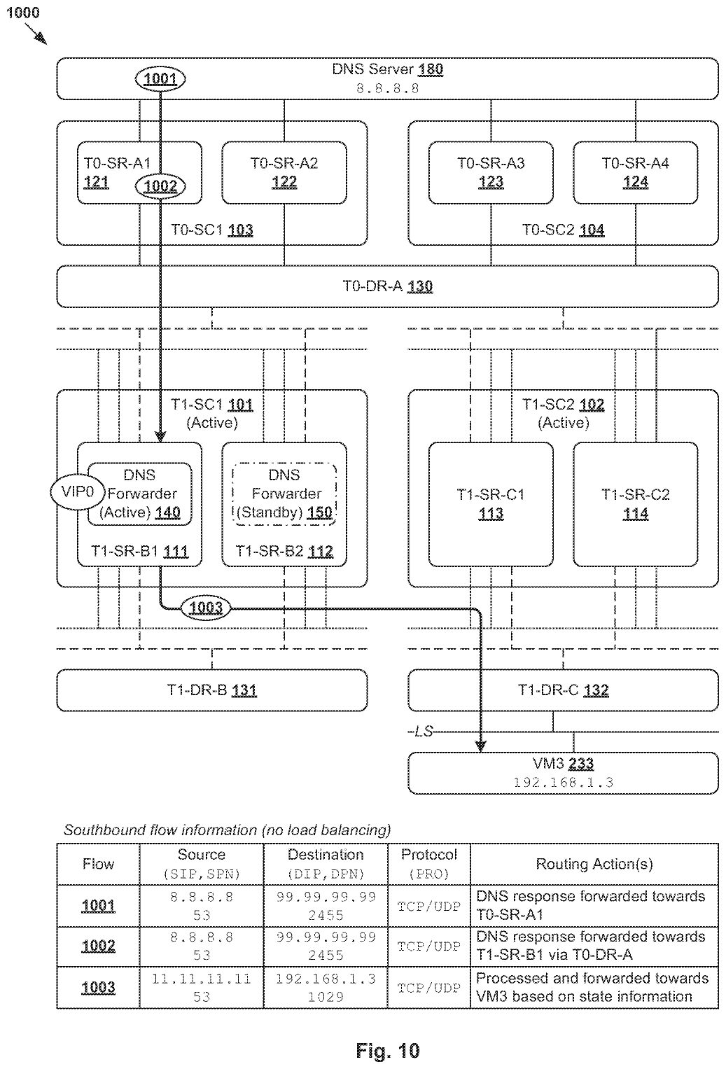

Examples of the present disclosure may be implemented together with, or without, logical load balancing to distribute traffic/workload among T1-SRs 111-114 and/or TO-SRs 121-124 according to a scale-out model. When load balancing is enabled in the active-active cluster, the service request may be forwarded or punted towards another logical SR (e.g., second logical SR in first sub-cluster 101 or third logical SR in second sub-cluster 102) before being redirected. In this case, prior to performing blocks 310-340 in FIG. 3, any suitable configurations may be performed to facilitate packet redirection towards first service endpoint 140 on the first logical SR. Various examples will be discussed below using FIG. 4 (detailed process), FIGS. 5-6 (example configurations), FIGS. 7-8 (load balancing enabled) and FIGS. 9-10 (no load balancing).

Example Configurations

FIG. 4 is a flowchart of example detailed process 400 for a computer system to perform centralized service insertion in an active-active logical SR cluster. Example process 400 may include one or more operations, functions, or actions illustrated by one or more blocks, such as 410 to 480. The various blocks may be combined into fewer blocks, divided into additional blocks, and/or eliminated depending on the desired implementation. Some examples of block 410 in FIG. 4 will be described using FIG. 5, which is a schematic diagram illustrating example configurations to facilitate centralized service insertion in an active-active logical SR cluster. The following notations will be used below: SIP=source IP address, SPN=source port number, DIP=destination IP address, DPN=destination port number, PRO=service protocol, etc.

(a) Active-Active Clusters

At 510 in FIG. 5, management entity 280/282 may configure a cluster of T1-SRs 111-114 on the lower tier. The cluster may include T1-SR-B1 (see 111), T1-SR-B2 (see 112), T1-SR-C1 (see 113) and T1-SR-C2 (see 114). To implement HA mode=active-active on the lower tier, a first active sub-cluster (denoted as T1-SC1; see 101) may be configured to include T1-SR-B1 111 and T1-SR-B2 112. A second active sub-cluster (denoted as T1-SC2; see 102) may include T1-SR-C1 113 and T1-SR-C2 114. First sub-cluster 101 and second sub-cluster 102 may be configured to operate in an active-active mode, i.e. at least one T1-SR is active within a particular sub-cluster at one time. One of the sub-clusters (e.g., first sub-cluster 101) may be configured as the default sub-cluster to implement service endpoints (to be discussed below).

At 520 in FIG. 5, management entity 280/282 may configure a cluster of TO-SRs 121-124 on the upper tier (see also FIG. 1). Similarly, to implement an active-active mode on the upper tier, a first sub-cluster (denoted as T0-SC1; see 103) may be configured to include T0-SR-A1 121 and T0-SR-A2 122. A second sub-cluster (denoted as T0-SC2; see 104) to include T0-SR-A3 123 and T0-SR-A4 124. Similar to T1, first sub-cluster 103 and second sub-cluster 104 may operate in an active-active mode, i.e. at least one T0-SR is active within a particular sub-cluster at one time. See also 411 in FIG. 4.

(b) Active-Standby Service Endpoints

At 530 in FIG. 5, management entity 280/282 may configure a pair of active-standby service endpoints 140-150 to implement a centralized service, such as DNS forwarding, etc. Using an active-standby configuration, first service endpoint 140 (i.e., first DNS forwarder) may operate in an active mode on T1-SR-B1 111. Second service endpoint 150 (i.e., second DNS forwarder) may operate in a standby mode on T1-SR-B2 112 as a backup. Service endpoints 140-150 are configured on “default” sub-cluster=first sub-cluster 101.

In practice, service endpoint 140/150 may be configured to implement an instance of a DNS forwarder to relay DNS packets between hosts 210A-B and external DNS server 180. In this case, DNS forwarder configuration 530 may involve assigning listener IP address=11.11.11.11 and source virtual IP address=99.99.99.99 to both service endpoints 140-150 to implement the service. In practice, a listener may be an object that is configured to listen or check for DNS requests on the listener IP address=11.11.11.11. From the perspective of host 210A/B, DNS requests may be addressed to (DIP=11.11.11.11, DPN=53). DNS forwarder configuration 530 may further involve configuring a source IP address=99.99.99.99 for service endpoint 140/150 to interact with upstream DNS server 180 associated with IP address=8.8.8.8 and port number=53. Route advertisement (RA) is also enabled. See also 412 in FIG. 4.

At 540 in FIG. 5, management entity 280/282 may assign active-standby service endpoints 140-150 to a default service group to implement centralized service(s). For example, at 541, span configuration may involve configuring T1-SR-B1 111 (i.e., rank=0) and T1-SR-B2 112 (i.e., rank=1) as members of the service group. See also 413 in FIG. 4.

In practice, the service group may be configured on sub-cluster 101 to deploy active-standby service(s) on that cluster 101. The service group may manage its own HA state for the active-standby service in a preemptive and/or non-preemptive manner. Any suitable approach may be used for service group configuration, such as based on a message(s) from management entity 280/282. The message (e.g., dnsForwarderMsg) may specify a service group ID that is unique to a particular service group, a preemptive flag, associated cluster or sub-cluster ID, etc. The service configuration may span all sub-clusters 101-102 but the service only runs on active service endpoint 140.

At 542 in FIG. 5, virtual IP address configuration may involve assigning virtual IP addresses to the service group, including (a) VIP0=169.254.2.0 that is applicable to sub-cluster inter-SR, (b) listener IP address=11.11.11.11 that is applicable to sub-cluster SR loopback, and (c) source virtual IP address=99.99.99.99 that is also applicable to sub-cluster SR loopback. Further, at 543, service state route configuration may involve configuring routing information (destination=11.11.11.11, next hop=VIP0) for forwarding DNS requests from host 210A/210B towards service endpoint 140/150, and (destination=99.99.99.99, next hop=VIP0) for forwarding DNS responses from DNS server 180 towards service endpoint 140/150

(c) Logical Switch Configuration

At 550 in FIG. 5, management entity 280/282 may configure transit logical switches to facilitate implementation of the active-standby service provided by T1-SR-B1 111 and T1-SR-B2 112. At 551, a backplane LS or segment associated with network address=169.254.1.0/24 may be configured to facilitate routing from T1-DR-B 131 towards first sub-cluster 101. Also, a first pair of floating IP addresses may be configured, such as (FIP1=169.254.1.1, FIP2=169.254.1.2) to reach respective T1-SR-B1 111 and T1-SR-B2 112 via the backplane LS.

At 552 in FIG. 5, an inter-SR logical switch associated with network address=169.254.2.0/24 may be configured to facilitate inter-SR routing. An inter-SR VIP address denoted as VIP0=169.254.2.0 may be configured for use as the next hop of an inter-SR static route (i.e., DNS forwarder service route) via the inter-SR logical switch. Further, at 553, a router link LS associated with network address=100.64.0.0/24 may be configured to facilitate routing from TO-DR-A 130 towards first sub-cluster 101. A second pair of floating IP addresses may be configured, such as (FIP3=100.64.0.3, FIP4=169.254.1.2) attached to respective T1-SR-B1 111 and T1-SR-B2 112 via the router link LS. See also 414 in FIG. 4.

In practice, a virtual IP address may be floated or moved from one entity to another in a preemptive or non-preemptive manner to support HA implementation. Some examples will be explained using FIG. 6, which is a schematic diagram illustrating active-standby service endpoints 140-150 before, during and after a failover. First, at 610-630, when T1-SR-B1 111 is UP and running, (VIP0=169.254.2.0, FIP1=169.254.1.1, FIP3=100.64.0.3) may be attached to T1-SR-B1 111 to attract DNS traffic towards first service endpoint 140 operating in active mode. However, at 640, T1-SR-B1 111 may transition from UP to DOWN in the event of a failure, such as software failure, hardware failure, network failure, or a combination thereof.

At 650-670 in FIG. 6, when T1-SR-B1 111 is DOWN, a failover process may be initiated to float or move (VIP0=169.254.2.0, FIP1=169.254.1.1, FIP3=100.64.0.3) towards T1-SR-B2 112. This is to facilitate forwarding of DNS traffic towards second service endpoint 150 operating in active mode instead of first service endpoint 160. In this case, T1-SR-B2 112 takes over VIP0, listener IP address=11.11.11.11, source IP address=99.99.99.99 and the DNS service dataplane. Depending on the desired implementation, VIP0=169.254.2.0 may be floated in a non-preemptive manner, and (FIP1=169.254.1.1, FIP3=100.64.0.3) in a preemptive manner.

At 680 in FIG. 6, T1-SR-B1 111 may transition from DOWN to UP once it recovers from failure. At 690, since VIP0=169.254.2.0 is floated in a non-preemptive manner, VIP0 may remain attached to T1-SR-B2 112 supporting active second service endpoint 150. In this case, first service endpoint 140 on T1-SR-B1 111 may operate in a standby mode to, for example, reduce the likelihood of service disruption caused by floating VIP0 back to T1-SR-B1 111. In contrast, at 695-696, (FIP1=169.254.1.1, FIP3=100.64.0.3) may be reattached with T1-SR-B1 111 after the recovery. In other words, (FIP1=169.254.1.1, FIP3=100.64.0.3) that are usually attached to T1-SR-B1 111 may be taken as a preemptive backup on peer T1-SR-B2 112.

(d) Inter-SR Static Route Configuration

At 560 in FIG. 7, management entity 280/282 may configure static routes towards service IP addresses associated with DNS forwarder 140/150 on T1-SRs that are not supporting active first service endpoint 140 (e.g., T1-SR-B2 112, T1-SR-C1 113 and T1-SR-C2 114). At 561, a first static route specifying (destination=99.99.99.99, next hop=VIP0) may be configured to direct DNS responses for destination=99.99.99.99 towards VIP0. At 562, a second static route specifying (destination=11.11.11.11, next hop=VIP0) may be configured to direct DNS requests for destination=11.11.11.11 towards VIP0.

(e) Route configuration on T1-DR and T0-DR

At 570 in FIG. 5, source IP address=99.99.99.99 associated with DNS forwarder 140/150 may be advertised to all TO-SRs, such as through a management plane auto-plumbing framework. At 571, route auto-plumbing may involve configuring a first static route specifying (destination=99.99.99.99, next hop=FIP3) on TO-DR-A 130. At 572, a second static route specifying (destination=11.11.11.11, next hop=FIP4) may be configured.

At 580 in FIG. 5, backplane routes may be pushed towards T1-DR-B 131 to reach service endpoint 140/150. At 581, a first static route specifying (destination=next hop=FIP1) may be configured to direct all packets towards FIP1. At 582, a second static route specifying (destination=0.0.0.0/0, next hop=FIP2) may be configured. Similar static routes may be configured on T1-DR-C 132 (not shown in FIG. 5 for simplicity).

### First Example: Load Balancing Enabled

Blocks 420-450 in FIG. 4 will be explained using FIG. 7, and blocks 420, 460-480 using FIG. 8. In particular, FIG. 7 is a schematic diagram illustrating first example 700 of centralized service insertion for northbound traffic with load balancing enabled. FIG. 8 is a schematic diagram illustrating second example 800 of centralized service insertion for southbound traffic with load balancing enabled. The term “northbound” may refer generally to a forwarding direction towards an external network. The term “southbound” may refer generally to the opposite forwarding direction from the external network towards the data center.

In the examples in FIG. 7-8, load balancing may be enabled for T1-SRs 111-114 on the lower tier and T0-SRs 121-124 on the upper tier. Any suitable load balancing protocol may be used. Using equal-cost multipath routing (ECMP) for example, four-way ECMP may be implemented on the lower tier for directing or punting traffic towards one of T1-SRs 111-114. Load balancing may also be enabled on the upper tier for directing or punting traffic towards one of TO-SRs 121-124.

(a) DNS Request (Northbound)

At 701 in FIG. 7, VM1 231 may generate and forward a service request=DNS request in a northbound direction. In this example, the DNS request is to resolve a domain name (e.g., www.xyz.com) to an IP address (e.g., IP-xyz). The DNS request may include header information (PRO=TCP, SIP=192.168.1.1, SPN=1029, DIP=11.11.11.11, DPN=53), where SIP=192.168.1.1 is associated with source=VM1 231 and DIP=11.11.11.11 is a listener IP address associated with service endpoint 140/150=DNS forwarder. The aim of the domain name resolution is for VM1 231 to communicate with an external server (not shown) associated with the resolved IP address (e.g., IP-xyz).

At 702 in FIG. 7, in response to detecting the DNS request, T1-DR-B 131 may forward the DNS request towards first service endpoint 140 operating in active mode on T1-SR-B1 111 in first sub-cluster 101. In practice, the DNS request may be forwarded based on routing table entry specifying (destination=0.0.0.0/0, next hop=FIP1), where FIP1 is currently attached to T1-SR-B1 111. As described using FIG. 5, FIP1 may be floated towards T1-SR-B2 112 in case of a failover and reattaches to T1-SR-B1 111 after failure recovery.

At 703 in FIG. 7, since load balancing is enabled, the DNS request may be punted towards T1-SR-C1 113 according to a four-way ECMP approach. T1-SR-C1 113 may be selected using, for example, a consistent hashing mechanism to calculate hash(11.11.11.11)=T1-SR-C1 113. The DNS request may be forwarded towards T1-SR-C1 113 via an inter-SR logical switch connecting T1-SRs 111-114.

At 704 in FIG. 7, in response to detecting the DNS request, T1-SR-C1 113 may redirect the DNS request towards T1-SR-B1 111 based on inter-SR static route 562 in routing table 560 in FIG. 5. For example, this involves T1-SR-C1 113 mapping DIP=11.11.11.11 in the DNS request to routing table entry specifying (destination=11.11.11.11, next hop=VIP0), where VIP0 is currently attached to T1-SR-B1 111.

At 705 in FIG. 7, once the DNS request is redirected, first service endpoint 140 running on T1-SR-B1 111 may process the DNS request and forward a processed DNS request towards external server 180. The processing may involve modifying header information of the DNS request from (PRO=TCP, SIP=192.168.1.1, SPN=1029, DIP=11.11.11.11, DPN=53) to (PRO=TCP, SIP=99.99.99.99, SPN=2455, DIP=8.8.8.8, DPN=53). As discussed using FIG. 5, SIP=99.99.99.99 is a source IP address associated with T1-SR-B1 111 for communicating with external server 180 associated with DIP=8.8.8.8. The processed DNS request may be sent towards external server 180 via any TO-SR, such as T0-SR-A1 121.

Further, at 705, T1-SR-B1 111 may also store state information associated with the DNS request to facilitate processing of a subsequent DNS response. Any suitable state information may be stored, such as (SIP=192.168.1.1, SPN=1029) associated with source=VM1 231 and the domain name (e.g., www.xyz.com) that needs to be resolved. See also 430-450 in FIG. 4.

(b) DNS Response (Southbound)

Referring now to FIG. 8, at 801, DNS server 180 may generate and send a DNS response in reply to the DNS request in FIG. 7. The DNS response may include an IP address (e.g., IP-xyz) associated with a domain name (e.g., www.xyz.com) specified in the corresponding DNS request. The DNS response may include header information (PRO=TCP, SIP=8.8.8.8, SPN=53, DIP=99.99.99.99, DPN=2455), where 99.99.99.99 is a source IP address associated with service endpoint 140/150. The DNS response is routed towards T0-SR-A4 124.

At 802 in FIG. 8, since load balancing is enabled, the DNS response may be punted from TO-SR-A4 124 towards T0-SR-A2 122 according to four-way ECMP. T0-SR-A2 122 may be selected using a consistent hashing mechanism, such as by calculating hash(8.8.8.8)=T0-SR-A2 124.

At 803 in FIG. 8, TO-SR-A2 122 may forward the DNS response towards T1-SR-B1 111 via a router link port. At T0-DR-A 130, the DNS response may be forwarded towards T1-SR-B1 111 based on the route auto-plumbing discussed using FIG. 5. For example (see 571 in FIG. 5), routing table entry specifying (DIP=99.99.99.99, next hop=FIP3) may be applied, where FIP3 is currently attached to T1-SR-B1 111.

At 804 in FIG. 8, since load balancing is enabled, the DNS response may be punted from T1-SR-B1 111 towards T1-SR-B2 112 according to four-way ECMP. T1-SR-B2 112 may be selected using a hash-based approach, such as by calculating hash(8.8.8.8)=T1-SR-B2 112.

At 805 in FIG. 8, since second service endpoint 150 is in standby mode, the DNS response may be redirected towards T1-SR-B1 111 based on inter-SR static route configuration discussed using FIG. 5. In particular, T1-SR-B2 112 may match the DNS response to static route entry (DIP=99.99.99.99, next hop=VIP0) for the redirection, where VIP0 is currently attached to T1-SR-B1 111. See 561 in FIG. 5.

At 806 in FIG. 8, first service endpoint 140 implemented by T1-SR-B1 111 may process the DNS response and forward a processed DNS response towards source VM1 231 via T1-DR-B 131. By processing the DNS response using T1-SR-B1 111 instead of T1-SR2 140 supporting second service endpoint 150 in standby mode, DNS forwarding may be performed on the return path. Note that second service endpoint 150 does not have any state information of the corresponding DNS request.

The processing by first service endpoint 140 may involve modifying the header information (e.g., tuple information) from (PRO=TCP, SIP=8.8.8.8, SPN=53, DIP=99.99.99.99, DPN=2455) to (PRO=TCP, SIP=11.11.11.11, SPN=53, DIP=192.168.1.1, DPN=1029) based on any suitable state information generated and stored at 705 in FIG. 7. See also 460-480 in FIG. 4.

In practice, load balancing may be enabled to punt packets towards one of T1-SRs 111-114 for traffic distribution purposes. Conventionally, punting is not able to ensure service session consistency when the destination IP address in the south-to-north direction is not the same as the source IP address in the north-to-south direction. For example, the DNS request addressed to DIP=11.11.11.11 is punted towards hash(11.11.11.11)=T1-SR-C1 113 in FIG. 7, while the DNS response addressed to SIP=8.8.8.8 is punted towards hash(8.8.8.8)=T1-SR-B2 112 in FIG. 8.

Using examples of the present disclosure, the DNS request and DNS response may be redirected towards VIP0 that is attached to first service endpoint 140 operating in active mode to facilitate service session consistency. Further, when second service endpoint 150 transitions from standby mode to active mode due to a failover, VIP0 is attached to second service endpoint 150 on T1-SR-B2 112. This way, DNS traffic may be redirected towards VIP0 to reach second service endpoint 150 to facilitate service session consistency.

### Second Example: No Load Balancing

Examples of the present disclosure may be implemented when load balancing is not enabled (i.e., no punting). Blocks 420-450 in FIG. 4 will be explained using FIG. 9, and blocks 420, 460-480 using FIG. 10. In particular, FIG. 9 is a schematic diagram illustrating first example 900 of centralized service insertion for northbound traffic with load balancing not enabled. FIG. 10 is a schematic diagram illustrating second example 1000 of centralized service insertion for southbound traffic with load balancing not enabled.

(a) DNS Request (Northbound)

At 901 in FIG. 9, VM3 233 may generate and forward a service request=DNS request in a northbound direction. Similar to FIG. 7, the DNS request is to resolve a domain name (e.g., www.abc.com) to an IP address (e.g., IP-abc). The DNS request may include header information (PRO=TCP, SIP=192.168.1.3, SPN=1029, DIP=11.11.11.11, DPN=53), where SIP=192.168.1.3 is associated with source=VM3 233 and DIP=11.11.11.11 is a listener IP address associated with service endpoint=DNS forwarder 140/150.

At 902 in FIG. 9, in response to detecting the DNS request, T1-DR-C 132 may forward the DNS request towards T1-SR-C1 113 based on a source-based routing (SBR) table. In this case, the DNS request may be matched to an SBR entry for 192.168.1.3/24 that causes the forwarding towards T1-SR-C1 113.

At 903 in FIG. 9, in response to detecting the DNS request, T1-SR-C1 113 may redirect the DNS request towards T1-SR-B1 111 based on inter-SR static route 562 in routing table 560 in FIG. 5. For example, this involves T1-SR-C1 113 mapping DIP=11.11.11.11 in the DNS request to routing table entry specifying (destination=11.11.11.11, next hop=VIP0), where VIP0 is currently attached to T1-SR-B1 111.

At 904 in FIG. 9, first service endpoint 140 running on T1-SR-B1 111 may process the DNS request and forward a processed DNS request towards external server 180. The processing may involve modifying header information (e.g., tuple information) of the DNS request from (PRO=TCP, SIP=192.168.1.3, SPN=1029, DIP=11.11.11.11, DPN=53) to (PRO=TCP, SIP=99.99.99.99, SPN=2455, DIP=8.8.8.8, DPN=53), where external server 180 associated with DIP=8.8.8.8.

Further, T1-SR-B1 111 may also store state information associated with the DNS request to facilitate processing of a corresponding DNS response. Any suitable state information may be stored, such as by storing (SIP=192.168.1.3, SPN=1029) associated with source=VM3 233 and the domain name (e.g., www.abc.com) that needs to be resolved.

(b) DNS Response (Southbound)

Referring now to FIG. 10, at 1001, DNS server 180 may generate and send a DNS response in reply to the DNS request in FIG. 9. The DNS response may include an IP address (e.g., IP-abc) associated with a domain name (e.g., www.abc.com) specified in the corresponding DNS request. The DNS response may include header information (PRO=TCP, SIP=8.8.8.8, SPN=53, DIP=99.99.99.99, DPN=2455), where 99.99.99.99 is a source IP address associated with service endpoint 140/150. The DNS response is routed towards T0-SR-A1 121.

At 1002 in FIG. 10, TO-SR-A1 121 may forward the DNS response towards T1-SR-B1 111 via a router link port. At TO-DR-A 130, the DNS response may be forwarded towards T1-SR-131 111 based on the route auto-plumbing discussed using FIG. 5. For example (see 571 in FIG. 5), routing table entry specifying (DIP=99.99.99.99, next hop=FIP3) may be applied, where FIP3 is currently attached to T1-SR-61 111.

At 1003 in FIG. 10, first service endpoint 140 implemented by T1-SR-B1 111 may process the DNS response and forward a processed DNS response towards source VM3 233 via T1-DR-C 132. The processing by first service endpoint 140 may involve mapping the DNS response to any suitable state information generated and stored at 905 in FIG. 9. Based on the matching state information, the header information (e.g., tuple information) may be modified from (PRO=TCP, SIP=8.8.8.8, SPN=53, DIP=99.99.99.99, DPN=2455) to (PRO=TCP, SIP=11.11.11.11, SPN=53, DIP=192.168.1.3, DPN=1029.

Stateless Reflexive Firewall Rules

According to examples of the present disclosure, stateless reflexive firewall rule(s) may be configured on TO-SR(s) on the upper tier when service endpoint(s) are supported by T1-SR(s) on the lower tier. In the examples in FIGS. 7-8 in which punting is enabled, stateless reflexive firewall rules may be configured on TO-SRs 121-124 for DNS forwarder service IP addresses to reduce the likelihood of half-open firewall sessions.

One example stateless reflexive firewall rule may specify (a) match criteria (SIP=99.99.99.99, SPN=ANY, DIP=8.8.8.8, DPN=53, PRO=TCP/UDP) and (b) action=ALLOW for outbound DNS requests towards DNS server 180 in FIGS. 7 and 9. Another example stateless reflexive firewall rule may specify (a) match criteria (SIP=8.8.8.8, SPN=53, DIP=99.99.99.99, DPN=ANY, PRO=TCP/UDP) and (b) action=ALLOW for inbound DNS responses from DNS server 180 in FIGS. 8 and 10. Depending on the desired implementation, zone-based firewall rules may be configured.

Container Implementation

Although discussed using VMs 231-234, it should be understood that centralized service insertion in active-active cluster may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 11s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies. Using the examples in the present disclosure, centralized service insertion in active-active cluster may be performed to facilitate secure communication among containers located at geographically dispersed sites in SDN environment 100.

Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 10. For example, a computer system (e.g., EDGE) capable of supporting a logical SR may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a computer system to perform centralized service insertion in an active-active cluster that includes a first logical SR supported by the computer system, a second logical SR and a third logical SR, wherein the method comprises:
operating, on the first logical SR, a first service endpoint in an active mode, wherein (a) the first service endpoint is associated with a second service endpoint operating on the second logical SR in a standby mode, and (b) the first logical SR and the second logical SR are assigned to a first sub-cluster of the active-active cluster; and
in response to receiving a service request originating from a virtualized computing instance via (a) a logical distributed router (DR), (b) the second logical SR in the first sub-cluster, or (c) the third logical SR in a second sub-cluster of the active-active cluster,
processing, using the first service endpoint, the service request according to a centralized service that is implemented by both the first service endpoint operating in the active mode and the second service endpoint operating in the standby mode; and
forwarding a processed service request towards a destination capable of generating and sending a service response in reply to the processed service request.

2. The method of claim 1, wherein receiving the service request comprises:
receiving the service request via an inter-SR logical switch connecting the first logical SR, the second logical SR and the third logical SR, wherein load balancing is enabled in the active-active cluster to cause the service request to be forwarded towards the second logical SR or the third logical SR prior to redirection towards the first logical SR.

3. The method of claim 2, wherein operating the first service endpoint in the active mode comprises:
attaching a first virtual address to the first service endpoint for use as a next hop in an inter-SR static route configured on the second logical SR or the third logical SR to forward the service request via the inter-SR logical switch, wherein the first virtual address is moveable to the second service endpoint capable of switching from the standby mode to the active mode in case of a failure affecting the first service endpoint.

4. The method of claim 1, wherein operating the first service endpoint in the active mode comprises:
assigning the first logical SR as a member of a service group, wherein the service group includes both the first logical SR and the second logical SR to implement the centralized service in the first sub-cluster.

5. The method of claim 1, wherein operating the first service endpoint in the active mode comprises:
attaching a second virtual address to the first service endpoint for use as a next hop for the logical DR to forward the service request towards the first service endpoint via a backplane logical switch or a router link logical switch, wherein the second virtual address is moveable to the second service endpoint capable of switching from the standby mode to the active mode in case of a failure affecting the first service endpoint.

6. The method of claim 1, wherein the method further comprises:
receiving, from the destination, the service response via (a) a logical DR, (b) the second logical SR in the first sub-cluster, or (c) the third logical SR in the second sub-cluster.

7. The method of claim 6, wherein the method further comprises:
in response to receiving the service response, processing the service response using the first service endpoint according to the centralized service; and
forwarding a processed service request towards the virtualized computing instance.

8. A non-transitory computer-readable storage medium that includes a set of instructions which, in response to execution by a processor of a computer system, cause the processor to perform a method for centralized service insertion in an active-active cluster, wherein the method comprises:
operating, on a first logical SR supported by the computer system, a first service endpoint in an active mode, wherein (a) the first service endpoint is associated with a second service endpoint operating on a second logical SR in a standby mode, and (b) the first logical SR and the second logical SR are assigned to a first sub-cluster of the active-active cluster; and
in response to receiving a service request originating from a virtualized computing instance via (a) a logical distributed router (DR), (b) the second logical SR in the first sub-cluster, or (c) a third logical SR in a second sub-cluster of the active-active cluster,
processing, using the first service endpoint, the service request according to a centralized service that is implemented by both the first service endpoint operating in the active mode and the second service endpoint operating in the standby mode; and
forwarding a processed service request towards a destination capable of generating and sending a service response in reply to the processed service request.

9. The non-transitory computer-readable storage medium of claim 8, wherein receiving the service request comprises:
receiving the service request via an inter-SR logical switch connecting the first logical SR, the second logical SR and the third logical SR, wherein load balancing is enabled in the active-active cluster to cause the service request to be forwarded towards the second logical SR or the third logical SR prior to redirection towards the first logical SR.

10. The non-transitory computer-readable storage medium of claim 9, wherein operating the first service endpoint in the active mode comprises:
attaching a first virtual address to the first service endpoint for use as a next hop in an inter-SR static route configured on the second logical SR or the third logical SR to forward the service request via the inter-SR logical switch, wherein the first virtual address is moveable to the second service endpoint capable of switching from the standby mode to the active mode in case of a failure affecting the first service endpoint.

11. The non-transitory computer-readable storage medium of claim 8, wherein operating the first service endpoint in the active mode comprises:
assigning the first logical SR as a member of a service group, wherein the service group includes both the first logical SR and the second logical SR to implement the centralized service in the first sub-cluster.

12. The non-transitory computer-readable storage medium of claim 8, wherein operating the first service endpoint in the active mode comprises:
attaching a second virtual address to the first service endpoint for use as a next hop for the logical DR to forward the service request towards the first service endpoint via a backplane logical switch or a router link logical switch, wherein the second virtual address is moveable to the second service endpoint capable of switching from the standby mode to the active mode in case of a failure affecting the first service endpoint.

13. The non-transitory computer-readable storage medium of claim 8, wherein the method further comprises:
receiving, from the destination, the service response via (a) a logical DR, (b) the second logical SR in the first sub-cluster, or (c) the third logical SR in the second sub-cluster.

14. The non-transitory computer-readable storage medium of claim 13, wherein the method further comprises:
in response to receiving the service response, processing the service response using the first service endpoint according to the centralized service; and
forwarding a processed service request towards the virtualized computing instance.

15. A computer system, comprising a first logical service router (SR) to:
operate, on the first logical SR, a first service endpoint in an active mode, wherein (a) the first service endpoint is associated with a second service endpoint operating on a second logical SR in a standby mode, and (b) the first logical SR and the second logical SR are assigned to a first sub-cluster of an active-active cluster; and
in response to receiving a service request originating from a virtualized computing instance via (a) a logical distributed router (DR), (b) the second logical SR in the first sub-cluster, or (c) a third logical SR in a second sub-cluster of the active-active cluster,
process, using the first service endpoint, the service request according to a centralized service that is implemented by both the first service endpoint operating in the active mode and the second service endpoint operating in the standby mode; and
forward a processed service request towards a destination capable of generating and sending a service response in reply to the processed service request.

16. The computer system of claim 15, wherein the first logical SR is to receive the service request by performing the following:
receive the service request via an inter-SR logical switch connecting the first logical SR, the second logical SR and the third logical SR, wherein load balancing is enabled in the active-active cluster to cause the service request to be forwarded towards the second logical SR or the third logical SR prior to redirection towards the first logical SR.

17. The computer system of claim 16, wherein the first logical SR is to operate the first service endpoint in the active mode by performing the following:
attach a first virtual address to the first service endpoint for use as a next hop in an inter-SR static route configured on the second logical SR or the third logical SR to forward the service request via the inter-SR logical switch, wherein the first virtual address is moveable to the second service endpoint capable of switching from the standby mode to the active mode in case of a failure affecting the first service endpoint.

18. The computer system of claim 15, wherein the first logical SR is to operate the first service endpoint in the active mode by performing the following:
assign the first logical SR as a member of a service group, wherein the service group includes both the first logical SR and the second logical SR to implement the centralized service in the first sub-cluster.

19. The computer system of claim 15, wherein the first logical SR is to operate the first service endpoint in the active mode by performing the following:
attach a second virtual address to the first service endpoint for use as a next hop for the logical DR to forward the service request towards the first service endpoint via a backplane logical switch or a router link logical switch, wherein the second virtual address is moveable to the second service endpoint capable of switching from the standby mode to the active mode in case of a failure affecting the first service endpoint.

20. The computer system of claim 15, wherein the first logical SR is further to performing the following:
receive, from the destination, the service response via (a) a logical DR, (b) the second logical SR in the first sub-cluster, or (c) the third logical SR in the second sub-cluster.

21. The computer system of claim 20, wherein the first logical SR is further to performing the following:
in response to receiving the service response, process the service response using the first service endpoint according to the centralized service; and
forward a processed service request towards the virtualized computing instance.
